(19) United States
(12) Patent Application Publication
(10) Pub. No.: US 2026/0097842 A1
(43) Pub. Date: Apr. 9, 2026

(54) PROPULSION ASSEMBLY FOR AN AIRCRAFT PROVIDED WITH A PROPELLER AND A CYCLIC PITCH DEVICE FOR THE BLADES OF THE PROPELLER AND METHOD FOR REGULATING THE CYCLIC PITCH OF THE BLADES OF THE PROPELLER

(71) Applicant: SAFRAN AIRCRAFT ENGINES, Paris (FR)

(72) Inventors: Laurent JABLONSKI, Moissy-Cramayel (FR); Clément COTTET, Moissy-Cramayel (FR); Jean Charles Olivier RODA, Moissy-Cramayel (FR); Arnaud Jimmy Marcel LANGLOIS, Moissy-Cramayel (FR); Olivier BELMONTE, Moissy-Cramayel (FR)

(73) Assignee: SAFRAN AIRCRAFT ENGINES, Paris (FR)

(21) Appl. No.: 19/418,343

(22) Filed: Dec. 12, 2025

Related U.S. Application Data
(63) Continuation of application No. PCT/FR2024/050759, filed on Jun. 11, 2024.

(30) Foreign Application Priority Data
Jun. 15, 2023 (FR) 23/06126

(51) Int. Cl. B64C 11/34; B64C 11/06; B64C 11/26; B64C 11/32; B64D 27/12; B64D 35/00

(52) U.S. Cl. CPC B64C 11/34; B64C 11/06; B64C 11/26; B64C 11/325; B64D 27/12; B64D 35/00

(57) ABSTRACT

A propulsion assembly for an aircraft extends along an axis and includes a propulsion module having a propeller provided with blades, an outlet guide vane, and a propeller shaft to rotate the propeller. The blades of the propeller are entirely or partially made of composite material. The propulsion assembly further includes a gas generator having a drive shaft; a speed-reduction device rotationally coupling the drive shaft and the propeller shaft to drive the propeller shaft at a rotational speed lower than the rotational speed of the drive shaft; and a cyclic pitch device for the blades of the propeller.

### CROSS-REFERENCE TO RELATED APPLICATIONS

This application is a continuation of International Application No. PCT/FR2024/050759, filed on Jun. 11, 2024, which claims priority to and the benefit of FR 23/06126 filed on Jun. 15, 2023. The disclosures of the above applications are incorporated herein by reference.

### FIELD

The present disclosure relates to a propulsion assembly for an aircraft provided with a propeller and a cyclic pitch device for the blades of the propeller, and a method for regulating the cyclic pitch of the blades of the propeller.

### BACKGROUND

The statements in this section merely provide background information related to the present disclosure and may not constitute prior art.

In the context of the present disclosure, the term “propulsion assembly for an aircraft provided with a propeller” designates all the gas turbine apparatuses producing a thrust necessary for the propulsion of an aircraft, in particular an airplane, by reaction to the high-speed ejection of gas, essentially by the propeller. The term “propeller” designates an unducted fan rotor. Propulsion assemblies for an aircraft provided with at least one propeller are also known by “open fan” or “unducted fan”.

Much research aims to improve the efficiency of the aeronautical engines, and in particular airplane engines, with a view to reducing their environmental and ecological impact. One of the identified areas for improving the propulsive efficiency of the airplane engines, reducing their consumption and the noise generated by the propulsion module, is to increase as much as possible the bypass ratio (or BPR), which corresponds to the ratio of the mass flow rate of the secondary air flow to the mass flow rate of the primary air flow. To do this, one of the solutions includes indirectly coupling the propulsion module and the gas generator, for example through a speed reduction device. Thus, it is possible to independently improve the rotational speed of the rotating spool(s) of the gas generator, on the one hand, and the rotational speed of the rotor of the propulsion module, on the other hand. However, improving the bypass ratio generally also involves an increase in the diameter of the propulsion module, and consequently the external dimensions of the propulsion assembly. This results in an increase in the mass, consumption and drag of the propulsion assembly, as well as more difficult integration within the airplane.

In addition, among engines with a high bypass ratio, propeller propulsion assemblies are subject to a mechanical stress called “1P” which is preponderant and must be taken into consideration in the dimensioning and design of the engine. This 1P stress (or 1P moment) is the result of a pressure differential exerted by the incident air flow on the blades of the propellers, linked to the rotation of the propeller. Indeed, since the incident air flow is generally not parallel to the rotational axis of the propeller, a pressure differential is exerted by this air flow on the diametrically opposed blades of the propeller. This generates a resulting stress on the entire propeller, as well as on the shaft carrying the propeller and on the entire chain transmitting motive power to the propeller. This stress and must be considered for the dimensioning of the engine. The propellers and the power transmission chain of airplane engines must generally be resistant from a mechanical point of view, and are sometimes provided with an active or passive cyclic pitch mechanism (see for example FR2997138, FR3067415 or FR3101664). However, this may penalize the mass of the engine, and therefore the efficiency of the engine.

### SUMMARY

This section provides a general summary of the disclosure and is not a comprehensive disclosure of its full scope or all of its features.

The present disclosure relates to a propulsion assembly for an aircraft. The propulsion assembly extends along an axis and comprises a propulsion module having a propeller provided with blades, an outlet guide vane, and a propeller shaft configured to drive the propeller in rotation. The blades of the propeller are made in whole or in part of composite material. The propulsion assembly further comprises a gas generator having a drive shaft, a speed reduction device rotatably coupling the drive shaft and the propeller shaft, and configured to drive the propeller shaft at a rotational speed lower than the rotational speed of the drive shaft, and a cyclic pitch device for the blades of the propeller. The cyclic pitch device can be associated with a stator in the propulsion assembly or with the propeller which is connected to the propeller shaft associated with the reduction device.

Generally, in the present disclosure and unless otherwise indicated, upstream and downstream are defined relative to the normal flow direction of the fluid (from upstream to downstream) through the propulsion assembly. Furthermore, the axial direction corresponds to the direction of the axis of the propulsion assembly, and a radial direction is a direction perpendicular to the axis. The azimuthal or circumferential direction corresponds to the direction describing a ring around the axial direction. The three axial, radial and azimuthal directions correspond respectively to the directions defined by the side, the radius and the angle in a cylindrical coordinate system. Finally, unless otherwise indicated, the adjectives “inner” “internal” and “outer” “external” are used in reference to a radial direction such that the inner (i.e. radially inner) part of an element is closer to the axis than the outer (i.e. radially outer) part of the same element.

Hereinafter, and unless otherwise indicated, “propulsion assembly” means “propulsion assembly for an aircraft”. Hereinafter, and unless otherwise indicated, “cyclic pitch device” means “cyclic pitch device for the blades of the propeller”.

An outlet guide vane is a bladed wheel rotatably stationary about the axis of the propulsion assembly (i.e. the outlet guide vane is a stator), the propeller being a bladed wheel rotatably movable about the axis of the propulsion assembly (i.e. the propeller is a rotor). The outlet guide vane, generally disposed downstream of the propeller, has the function of straightening the air flow downstream of the propeller along the axis.

The gas generator may be a single-, double-or triple-spool gas generator, and comprises from upstream to downstream, along the axis, a compressor (or compressor section), a combustion chamber, and a turbine (or turbine section).

For the purposes of the present disclosure, the term “composite material” means a material comprising reinforcing fibers, for example long reinforcing fibers, for example of a length greater than or equal to 1 cm (one centimeter), embedded in a matrix made of polymeric material, for example an epoxy resin. For example, the fibers may comprise strands of carbon fibers. According to another example, the fibers may comprise strands of glass fibers within strands of carbon fibers. Examples of such materials are described in EP2588758, WO2022018353 or WO2022208002. For example, 3D woven or laminated blades are considered to be blades made of composite material. Each blade of the propeller may be entirely made of composite material, or may comprise a part, for example the airfoil, made of composite material, and another part, for example the root and/or an internal spar extending longitudinally from the root inside the airfoil, made of another material, for example metal.

As a reminder, the pitch or pitch angle of a blade corresponds to the angle made by a chord of the blade, the chord being an abstract geometric segment extending, at a given height of the airfoil, between the leading edge and the trailing edge of the blade, with the rotational axis of the propeller within which the blade is mounted. A cyclic pitch device is a device configured to adjust the pitch of each blade of the propeller based on its angular position about the axis of the propeller, during the rotation of the propeller about its axis. The cyclic pitch of the blades is different from a possible collective pitch of the blades in that it is specific to each of the blades and different for each of the blades of the propeller, at least for the adjacent blades within the propeller. A collective pitch corresponds to a pitch common to all the blades of the propeller. In other words, a cyclic pitch angle may be considered as a compensation or correction pitch angle, specific to each blade taken individually and based on the angular position of the blade about the rotational axis of the propeller, of a collective pitch angle (fixed or variable) common to all the blades. A cyclic pitch device may be configured to adjust only the cyclic pitch of the blades, or to adjust the cyclic pitch and any collective pitch of the blades. A cyclic pitch device may be separate from any collective pitch device, or also form a collective pitch device.

The inventors have identified that in the context of an “open fan” type propulsion assembly, the cyclic pitch device makes it possible to reduce the mechanical loads on each of the blades of the propeller linked to the 1P stresses, which makes it is possible to use blades made in whole or in part of composite material, having a different resistance from a mechanical point of view than that of more traditional materials such as metal, and lighter. The combination of the use of a cyclic pitch device and blades made in whole or in part of composite material creates a synergy which leads to a reduction in the mechanical loads generated by the 1P stresses within the chain transmitting the engine torque to the propeller, which allows a more favorable dimensioning of the various involved elements in terms of mass, and therefore improves the efficiency. This also allows for better balance of the aircraft on which the propulsion assembly is mounted, for example by specifically managing the overhang of the propulsion assembly relative to the wing which supports it on the aircraft.

In some variations, the propeller shaft may be coaxial with the drive shaft.

In other words, the axis of the propeller shaft and the axis of the drive shaft may be coaxial and coincide with the axis of the propulsion assembly.

Such a configuration allows the use of a simpler outer casing of the gas generator with a relatively reduced mass. Furthermore, the stability of the air flow supplying the gas generator is improved while the part of the blades of the propeller radially closer to the axis performs a first compression of the air flow supplying the gas generator, upstream of the gas generator, which improves the efficiency.

In some variations, the cyclic pitch device for the blades of the propeller may comprise exactly three or four cylinders.

The cylinders may be of the “single chamber” or “double chamber” type. All cylinders may be of the same type, but not necessarily. Generally, they are associated with a stator in the propulsion assembly and allow to control a movement associated with the propeller in the cyclic pitch device for the blades of the propeller via members rotating in correlation with the propeller shaft.

Such a number of cylinders allows optimization of the mass of the cyclic pitch device while providing a satisfactory level of operation. Indeed, three cylinders are sufficient to provide the operation of the cyclic pitch device. For example, if at least one of these three cylinders (therefore providing exactly three cylinders) is of the “double chamber” type, a certain redundancy is obtained that is sufficient to provide the required availability of the cyclic pitch device with an acceptable impact on the overall mass of the system. According to a variant, by using “single chamber” type cylinders, a fourth cylinder (therefore providing exactly four cylinders) makes it possible to provide sufficient redundancy to provide the required availability of the cyclic pitch device with an acceptable impact on the overall mass of the system.

In some variations, the cylinders may be regularly distributed circumferentially about the axis.

Such a configuration makes it possible to distribute the mass of the cylinders evenly within the propulsion assembly, a good distribution of the forces generated by the cylinders, and therefore an optimization which makes it possible to reduce the capacity as much as possible, and therefore the mass of the cylinders.

In some variations, the cyclic pitch device for the blades of the propeller may comprise at least one cylinder, the at least one cylinder being configured to adopt a position within a total collective pitch stroke, and to allow a cyclic pitch stroke between ±40 mm (plus or minus forty millimeters), for example between ±20 mm (plus or minus twenty millimeters), for example between ±16 mm (plus or minus sixteen millimeters), for example between ±9.6 mm (plus or minus nine millimeters and six tenths of a millimeter), around said position. For example, all the cylinders may be identical and configured to adopt a position within a total collective pitch stroke, and to allow a cyclic pitch stroke of ±40 mm (plus or minus forty millimeters), for example between ±20 mm (plus or minus twenty millimeters), for example between ±16 mm (plus or minus sixteen millimeters), for example between ±9.6 mm (plus or minus nine millimeters and six tenths of a millimeter), around said position.

It is understood that the cylinder may have a sliding rod, this sliding rod having a reference point, for example the distal end of the rod, and that this reference point is movable between two extreme positions defining the total stroke of the cylinder, this total stroke allowing collective pitch according to a total collective pitch stroke and cyclic pitch for all positions of the cylinder within the total collective pitch stroke. Such a configuration makes it possible to use cylinders having a sufficient stroke and an improved mass.

In some variations, the cyclic pitch device for the blades of the propeller may comprise a pitch ring ball-jointed about the axis and sliding parallel to the axis.

It is understood that the pitch ring is ball-jointed about the axis, for example to provide the cyclic pitch of the blades. The pitch ring is sliding along the axis, for example to provide collective pitch. Such a ring may make it possible to reduce the overall mass of the system, improve the guidance, the rigidity of the assembly as well as the precision of the pitch.

In some variations, the pitch ring may be slidably mounted on the propeller shaft or on a stator.

The mounting on the propeller shaft or on a stator makes it possible to improve the overall size and kinematic efficiency of the system, and indirectly makes it possible to improve the mass of the assembly. Such a mounting may also make it possible to limit the overhang of the kinematics, which thus has better rigidity and better pitch precision.

In some variations, the pitch ring may have an internal radius between 150 mm (one hundred and fifty millimeters) and 450 mm (four hundred and fifty millimeters), for example 225 mm (two hundred and twenty-five millimeters).

Such dimensions make it possible to improve the overall size and kinematic efficiency of the system, and indirectly make it possible to improve the mass of the assembly. For example, this allows the ring to be integrated into the space available under the hub of the propeller.

In some variations, the pitch ring may be ball-jointed over an angular range between ±30° (plus or minus thirty degrees of angle), for example between ±15° (plus or minus fifteen degrees of angle), for example between ±10.5° (plus or minus ten degrees of angle and five tenths of a degree of angle) for example approximately ±4.0° (plus or minus four degrees of angle).

Such a range of ball joint movement makes it possible to provide the efficiency required for a propulsion assembly of the “open fan” type in its aerodynamic context, on an aircraft, for example an airplane, in flight, while being dimensioned as precisely as possible, which indirectly makes it possible to improve the mass of the assembly. In addition, a large angular range may improve the precision of the system.

In some variations, the cyclic pitch device for the blades of the propeller may comprise a pressure accumulator configured to provide control energy to bring the blades (i.e. all blades) to the feather position.

The “feather” position of the blades corresponds to the position of the blades which reduces the master torque of the propeller. In other words, the pitch associated with the “feather” position is the pitch which reduces the drag of the propeller relative to the air flow passing through the propeller.

Such a pressure accumulator is a reliable system (in particular due to the physical proximity between the accumulator and the actuators or cylinders, which improves the chances of the system withstanding extreme accidents such as loss of a propeller blade) and relatively light compared to other similar systems.

In some variations, the cyclic pitch angle may be between ±30° (plus or minus thirty degrees of angle), e.g. ±6° (plus or minus six degrees of angle).

Such a cyclic pitch angle amplitude provides the efficiency required for a propulsion assembly of the “open fan” type in its aerodynamic context, on an aircraft, for example an airplane, in flight, while being dimensioned as precisely as possible, which indirectly makes it possible to improve the mass of the assembly.

In some variations, the propeller may have a diameter measured at the leading edge greater than or equal to 1.98 m (one meter and ninety-eight hundredths of a meter) and less than or equal to 6.12 m (six meters and twelve hundredths of a meter), for example greater than or equal to 1.98 m (one meter and ninety-eight hundredths of a meter) and less than or equal to 4.30 m (four meters and thirty hundredths of a meter).

Such blades make it possible to improve the overall efficiency of the propulsion assembly mounted on an aircraft, for example an airplane, according to the need associated with the category of the airplane (e.g. number of seats), which indirectly makes it possible to improve the mass of the assembly. Furthermore, a large propeller diameter may make it possible to improve the propulsive efficiency despite the increase in mass that this may represent.

In some variations, the propeller may comprise at least 10 (ten) blades and at most 18 (eighteen) blades.

Such a number of blades provides the required aerodynamic and acoustic efficiency, and therefore satisfactory overall efficiency of the propulsion assembly, while optimizing the mass of the propulsion assembly.

In some variations, the propeller may have a hub-tip ratio greater than or equal to 0.22 (twenty-two hundredths) and less than or equal to 0.35 (thirty-five hundredths), for example greater than or equal to 0.25 (twenty-five hundredths) and less than or equal to 0.35 (thirty-five hundredths), for example less than or equal to 0.27 (twenty-seven hundredths).

The hub-tip ratio is the ratio of the internal radius of the propeller to the external radius of the propeller. The internal radius is the radial distance between the rotational axis of the propeller and the point of intersection of the leading edge of the airfoil of the blades of the propeller with the aerodynamic surface of the internal inter-blade platform. The external radius corresponds to the distance between the rotational axis of the propeller and the point of intersection between the leading edge of the airfoil of the blades of the propeller and the tip of the blades of the propeller (and corresponds to half the diameter of the propeller). The smaller the hub-tip ratio, the more efficient the propeller is and the greater the mechanical load experienced by the hub.

Such a hub-tip ratio makes it possible to provide the required aerodynamic and acoustic efficiency, and therefore satisfactory overall efficiency of the propulsion assembly, while optimizing the mass of the propulsion assembly.

In some variations, the propeller may comprise at least 10 (ten) blades and at most 16 (sixteen) blades and the hub-tip ratio may be greater than or equal to 0.25 (twenty-five hundredths) and less than or equal to 0.30 (thirty hundredths).

Such a combination of the number of blades and of the hub-tip ratio makes it possible to provide improved aerodynamic and acoustic efficiency, and therefore overall efficiency of the propulsion assembly, which further improves the mass of the propulsion assembly.

In some variations, the propeller may comprise at least 14 (fourteen) blades and at most 18 (eighteen) blades and the hub-tip ratio may be greater than or equal to 0.30 (thirty-hundredths) and less than or equal to 0.35 (thirty-five hundredths).

Such a combination of the number of blades and of the hub-tip ratio makes it possible to provide improved aerodynamic and acoustic efficiency, and therefore overall efficiency of the propulsion assembly, which further makes it possible to improve the mass of the propulsion assembly.

In some variations, the speed reduction device may have a reduction ratio greater than or equal to 2.5 (two and five tenths) and less than or equal to 11.0 (eleven), for example greater than or equal to 2.7 (two and seven tenths) and less than or equal to 6.0 (six), for example greater than or equal to 2.7 (two and seven tenths) and less than or equal to 3.6 (three and six tenths), for example around 3.0 (three).

Such a reduction ratio makes it possible to improve, on the one hand, the efficiency of the turbine of the gas generator and, on the other hand, the efficiency of the propeller based on its external diameter at the blade tip, which indirectly makes it possible to improve the mass and efficiency of the propulsion assembly.

In some variations, the gas generator may comprise a high-pressure spool and a low-pressure spool.

It is understood that the high-pressure spool comprises a high-pressure compressor rotatably coupled with a high-pressure turbine through a high-pressure shaft. The low-pressure spool comprises a low-pressure compressor disposed upstream of the high-pressure compressor, and a low-pressure turbine, disposed downstream of the high-pressure turbine, and rotatably coupled with the low-pressure compressor through a low-pressure shaft. The low-pressure shaft may form the drive shaft of the gas generator. The compressor of the gas generator comprises the low-pressure and high-pressure compressors. The turbine of the gas generator comprises the low-pressure and high-pressure turbines.

This makes it possible to improve the overall efficiency of the propulsion assembly, and in particular the thrust, consumption, efficiency of the compressor and of the turbine in an “open fan” context, which indirectly makes it possible to improve the mass of the propulsion assembly.

In some variations, the low-pressure spool may comprise a low-pressure turbine, the low-pressure turbine having at least 3 (three) stages and at most 8 (eight) stages.

This makes it possible to improve the overall efficiency of the propulsion assembly, and in particular the low-pressure turbine in an “open fan” context, which indirectly makes it possible to improve the mass of the propulsion assembly.

In some variations, the low-pressure spool may comprise a low-pressure compressor, the low-pressure compressor having at least 2 (two) stages and at most 5 (five) stages.

This makes it possible to improve the overall efficiency of the propulsion assembly, and in particular the low-pressure compressors in an “open fan” context, which indirectly makes it possible to improve the mass of the propulsion assembly.

In some variations, the high-pressure spool may comprise a high-pressure turbine, the high-pressure turbine having 2 (two) stages.

This makes it possible to improve the overall efficiency of the propulsion assembly, and in particular the high-pressure turbine in an “open fan” context, which indirectly makes it possible to improve the mass of the propulsion assembly.

In some variations, the high-pressure spool may comprise a high-pressure compressor, the high-pressure compressor having at least 8 (eight) stages and at most 11 (eleven) stages.

This makes it possible to improve the overall efficiency of the propulsion assembly, and in particular the high-pressure compressors in an “open fan” context, which indirectly makes it possible to improve the mass of the propulsion assembly.

In some variations, the cyclic pitch device for the blades of the propeller may be configured to regulate the cyclic pitch of the blades of the propeller based on one or several parameters of the aircraft on which the propulsion assembly is configured to be mounted, such as at least one parameter among the aircraft angle of attack, the roll, and the yaw.

The aircraft angle of attack, measured in degrees of angle, corresponds to the angle formed between the axis of the fuselage of the aircraft and the velocity vector of the aircraft projected onto the median plane of the aircraft extending between the wings. The roll, measured in degrees of angle, corresponds to the angular position of the aircraft about the axis of the fuselage relative to the horizontal reference position. The yaw, measured in degrees of angle, corresponds to the angle formed between the axis of the fuselage of the aircraft and the velocity vector of the aircraft projected onto the plane of the aircraft comprising the wings.

Regulation based on such parameters makes it possible to improve the overall efficiency of the propulsion assembly, considered in its aerodynamic environment within an aircraft, for example an airplane, in flight.

In some variations, the cyclic pitch device for the blades of the propeller may be configured to regulate the cyclic pitch of the blades of the propeller based on one or several parameters of the gas generator, such as based on at least one parameter among the speed, the power, or the torque, such as the torque of a low-pressure spool.

Regulation based on such parameters makes it possible to improve the overall efficiency of the propulsion assembly.

In some variations, the cyclic pitch device for the blades of the propeller may comprise at least one sensor, for example disposed on at least one of the propeller shaft, a propeller bearing support, a member controlling the cyclic pitch device for the blades of the propeller, for example a pitch ring or a cylinder, the at least one sensor being configured to determine a 1P moment.

Such a sensor may make it possible to pilot the cyclic pitch device without using aircraft-specific parameters.

In some variations, the cyclic pitch device for the blades of the propeller may comprise an inertial unit configured to determine the angle of attack, the roll, and the yaw of the aircraft on which the propulsion assembly is mounted.

Such an inertial unit may make it possible to pilot the cyclic pitch device without using aircraft-specific parameters.

A variation relates to a method for regulating the cyclic pitch of the blades of the propeller of the propulsion assembly according to any one of the variations described in the present disclosure, in which the cyclic pitch of the blades of the propeller is regulated based on at least one aircraft parameter on which the propulsion assembly is configured to be mounted and/or at least one parameter of the gas generator.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 represents an aircraft equipped with a propulsion assembly,

FIG. 2 represents a sectional view of the propulsion assembly of FIG. 1,

FIG. 3 represents a schematic sectional view of a speed reduction device of the planetary type,

FIG. 4 represents a schematic sectional view of a speed reduction device of the epicyclic type,

FIG. 5 represents a schematic sectional view of the cyclic pitch device of the propulsion assembly of FIG. 1, according to a first variant,

FIG. 6 represents a schematic sectional view of the cyclic pitch device of the propulsion assembly of FIG. 1, according to a second variant,

FIG. 7 is a graph representing the cyclic pitch of the blades of the propeller based on the angular position of the blades,

FIG. 8 represents a schematic view of the blades of the propeller of the propulsion assembly of FIG. 1, seen according to arrow VIII of FIG. 1, and

FIG. 9 represents steps of a method for regulating the cyclic pitch of the blades of the propeller of the propulsion assembly of FIG. 1.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

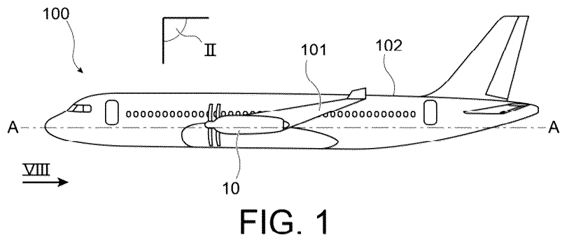

FIG. 1 represents an aircraft 100, in this example an airplane, equipped with two propulsion assemblies 10, namely one propulsion assembly 10 per wing 101, a single propulsion assembly 10 and a single wing 101 being represented on FIG. 1. According to a variant, the aircraft 100 may be equipped with more than one propulsion assembly 10 per wing 101, each wing 101 being provided with the same number of propulsion assemblies 10. The reference sign “A” designates the axis of the fuselage 102 of the aircraft 100. The propulsion assembly 10 may be configured to propel the aircraft 10 at a cruising speed between Mach 0.7 and Mach 0.9.

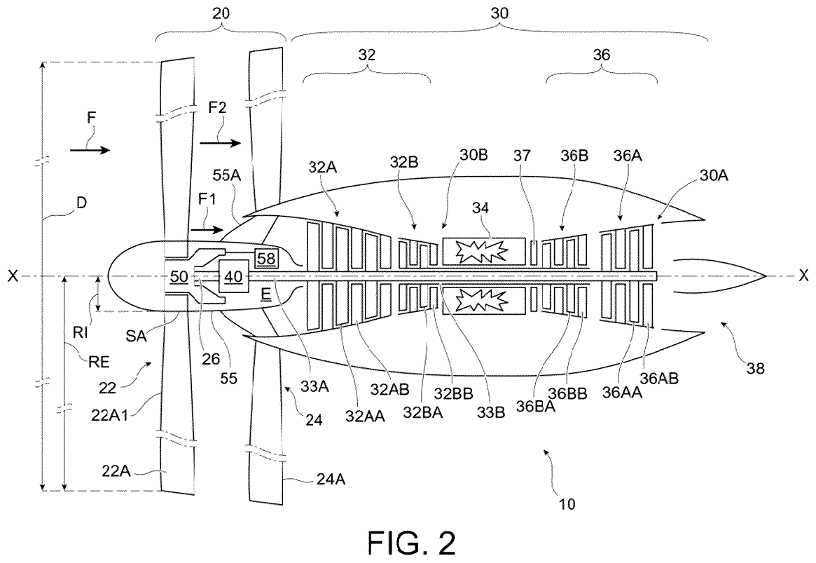

FIG. 2 represents a schematic sectional view of the propulsion assembly 10, according to the plan II of FIG. 1. The propulsion assembly 10 extends along an axis X, and comprises a propulsion module 20, a gas generator 30, a speed reduction device 40 and a cyclic pitch device 50. When the propulsion assembly 10 is mounted on the aircraft 100, the axis X is not necessarily parallel to the axis A.

The propulsion module 20 has a propeller 22 provided with a plurality of blades 22A, an outlet guide vane 24 provided with a plurality of blades 24A, and a propeller shaft 26 configured to drive the propeller 22 in rotation. The propeller shaft 26 may extend along the axis X. The blades 22A of the propeller 22 may be made in whole or in part of composite material. The blades 24A of the outlet guide vane 24 may be made in whole or in part of composite material. For example, the propeller 22 may comprise between 10 and 18 blades 22A and the outlet guide vane 24 may comprise a smaller number of blades 24A, for example between 8 and 16 blades 24A. The pitch of the blades 24A of the outlet guide vane 24 may be fixed or variable.

The propeller 22 may have a diameter D measured at the leading edge greater than or equal to 1.98 m and less than or equal to 6.12 m, for example greater than or equal to 1.98 m and less than or equal to 4.30 m. The propeller 22 may have a hub-tip ratio RI/RE greater than or equal to 0.22 and less than or equal to 0.35, for example greater than or equal to 0.25 and less than or equal to 0.35, for example less than or equal to 0.27. The internal radius RI corresponds to the radial distance between the rotational axis X of the propeller 22 and the point of intersection of the leading edge 22A1 of the airfoil of the blades 22A of the propeller 22 with the aerodynamic surface SA of the internal inter-blade platform. The external radius RE corresponds to the distance between the rotational axis X of the propeller 22 and the point of intersection between the leading edge of the airfoil of the blades 22A of the propeller 22 and the tip of the blades of the propeller (and corresponds to half the diameter D of the propeller 22).

The propeller 22 may comprise at least 10 blades 22A and at most 18 blades 22A. According to a variant, the propeller 22 may comprise at least 10 blades 22A and at most 16 blades 22A and the hub-tip ratio RI/RE may be greater than or equal to 0.25 and less than or equal to 0.30. According to another variant, the propeller 22 may comprise at least 14 blades 22A and at most 18 blades 22A and the hub-tip ratio RI/RE may be greater than or equal to 0.30 and less than or equal to 0.35.

The gas generator 30 has a drive shaft 33A. The drive shaft may extend along the axis X. The propeller shaft 26 may be coaxial with the drive shaft 33A, and their respective rotational axis may coincide with the axis X of the propulsion assembly 10. This makes it possible to have an annular air inlet within the gas generator 30 coaxial with the axis X, whereby the outer casing of the gas generator has a relatively simple shape and has a certain symmetry of revolution, which tends to reduce possible air flow disturbances. In this example, the gas generator 30 comprises from upstream to downstream, the gases flowing within the propulsion assembly 10 from upstream to downstream, a compressor 32 (or compressor section 32), a combustion chamber 34, and a turbine 36 (or turbine section 36).

The gas generator 30 may be of the double-spool type and comprise a low-pressure spool 30A and a high-pressure spool 30B. The low-pressure spool 30A may comprise a low-pressure compressor 32A rotatably coupled with a low-pressure turbine 36A through a low-pressure shaft 33A which may form the drive shaft of the gas generator 30. The high-pressure spool 30B may comprise a high-pressure compressor 32B disposed downstream of the low-pressure compressor 32A and upstream of the combustion chamber 34, and a high-pressure turbine 36B, disposed downstream of the combustion chamber 34 and upstream of the low-pressure turbine 36A, and rotatably coupled with the high-pressure compressor 32B through a high-pressure shaft 33B. The compressor 32 of the gas generator 30 may comprise the low-pressure and high-pressure compressors 32A and 32B. The turbine 36 of the gas generator 30 may comprise the low-pressure and high-pressure turbines 36A and 36B. The low-pressure and high-pressure shafts 33A and 33B may be coaxial. The high-pressure shaft 33B may receive a portion of the low-pressure shaft 33A. According to a variant, the low-pressure 33A and high-pressure 33B shafts may be co-rotating, i.e. configured to rotate relative to each other in the same direction about the axis X. According to another variant, the low-pressure 33A and high-pressure 33B shafts may be counter-rotating, i.e. configured to rotate relative to each other in opposite directions about the axis X. The rotational speed of the low-pressure spool 33A may be lower than the rotational speed of the high-pressure spool 33B.

According to a variant not shown, the propulsion assembly may be of the triple-spool type. The turbine 36 may comprise an intermediate turbine disposed axially between the high-pressure turbine 36B and the low-pressure turbine 36A and configured to drive an intermediate compressor disposed axially between the low-pressure compressor 32A and the high-pressure compressor 32B through an intermediate shaft. The intermediate shaft may be housed between the low-pressure shaft 33A and the high-pressure shaft 33B. The intermediate shaft and the low-pressure shaft 33B may be co-rotating or counter-rotating relative to each other.

Each compressor 32A, 32B and turbine 36A, 36B may comprise a plurality of stages, each stage comprising a bladed wheel, respectively 32AA, 32BA, 36AA, 36BA, rotatably movable about the axis X (or rotor) and a bladed wheel, respectively 32AB, 32BB, 36AB, 36BB, fixed about the axis X (or stator). In this example, the low-pressure compressor 32A may have at least 2 stages and at most 5 stages, for example 2 stages, the high-pressure compressor 32B may have between 8 stages and 11 stages (only two stages being shown for clarity of the figure), the high-pressure turbine 36B may have 2 stages, and the low-pressure turbine 36A may have between 3 stages and 8 stages (only two stages being shown for clarity of the figure). An outlet guide vane 37, or bladed wheel rotatably stationary about the axis X, may be disposed downstream of the combustion chamber 34 and upstream of the high-pressure turbine 36B.

A speed reduction device 40 may indirectly rotatably couple the drive shaft 33A to the propeller shaft 26. The speed reduction device 40 may be configured to drive the propeller shaft 26 at a rotational speed lower than the rotational speed of the drive shaft 33A. The drive shaft 33A connects the low-pressure turbine 36A (or the low-pressure spool 30A) to an input of the speed reduction device 40 while the propeller shaft 26 connects an output of the speed reduction device 40 to the propeller 22. The propeller 22 is therefore driven by the low-pressure turbine 36A (or the low-pressure spool 30A) through the drive shaft 33A (or low-pressure shaft), the speed reduction device 40 and the propeller shaft 26. In this example, the speed reduction device 40 may be disposed, considered along the axis X, between an upstream end of the drive shaft 33A and a downstream end of the propeller shaft 36.

For example, the speed reduction device 40 may be an epicyclic gear train reduction device, for example of the “epicyclic” or “planetary” type according to the terminology sometimes used by those skilled in the art. Such a mechanism may comprise a single stage, two stages or more than two stages.

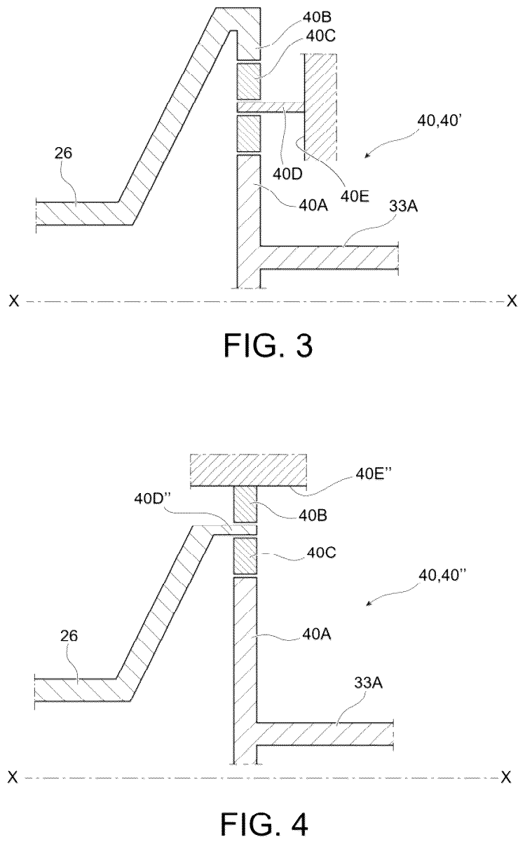

According to a first variant 40′ represented schematically on FIG. 3, the reduction device 40 may be of the planetary or “star” type and comprise a sun gear 40A, which forms the input of the reduction device 40. The rotational axis of the sun gear 40A forms the rotational axis of the reduction device 40, and may coincide with the axis X of the propulsion assembly 10. The sun gear 40A is configured to be driven in rotation by the drive shaft 33A. A ring gear 40B forms the output of the reduction device 40. The ring gear 40B is coaxial with the sun gear 40A and configured to drive the propeller shaft 26 in rotation about the axis X. Several planet gears 40C, or satellite gears—a single planet gear being shown in FIG. 3—are distributed circumferentially about the axis X between the sun gear 40A and the ring gear 40B. Each planet gear 40C is meshed with the sun gear 40A and with the ring gear 40B. The planet gears 40C are mounted on a planet carrier 40D which is fixed relative to a stator part 40E of the propulsion assembly 10, for example relative to a casing upstream of the compressor 32.

According to a second variant 40″ represented schematically in FIG. 4, the reduction device 40 may be of the epicyclic or “planetary” type. In this case, compared to the planetary type 40′ described with reference to FIG. 3, the ring gear 40B is fixedly mounted on a stator part 40E″ of the propulsion assembly 10 and the propeller shaft 26 is driven in rotation by the planet carrier 40D″ (which is therefore mobile in rotation relative to the stator part 40E″ of the propulsion assembly 10, for example relative to a casing upstream of the compressor 32). The stator parts 40E and 40E″ may correspond to different parts of the same element, or correspond to distinct elements.

Whatever the configuration 40′ or 40″ of the reduction device 40, the diameter of the ring gear 40B is greater than the diameter of the satellite carrier 40D, 40D″ which is itself greater than the diameter of the sun gear 40A, the planet gears 40C are radially disposed between the sun gear 40A and the ring gear 40B, and the rotational speed of the propeller shaft 26 is lower than the rotational speed of the drive shaft 33A.

The reduction ratio of the reduction device 40 may be greater than or equal to 2.5 and less than or equal to 11.0, for example greater than or equal to 2.7 and less than or equal to 6.0, for example greater than or equal to 2.7 and less than or equal to 3.6, for example equal to 3.0.

In operation, an air flow F (see FIG. 2) entering the propulsion assembly 10 passes through the propeller 22 and is then divided into a primary air flow F1 and a secondary air flow F2, which flow from upstream to downstream within the propulsion assembly 10.

The primary air flow F1 flows in a vein called the “primary vein”, inside the gas generator 30, sometimes also called the primary spool, passing successively through the low-pressure compressor 32A, the high-pressure compressor 32B, the combustion chamber 34, the high-pressure turbine 36B, the low-pressure turbine 36A, then through the outlet nozzle 38. The expansion of the combustion gases downstream of the combustion chamber 34 within the turbine 36 provides the energy to drive in rotation the high-pressure and low-pressure turbines 36B, 36A, and therefore the shafts 33A and 33B.

The secondary air flow F2, sometimes also called “bypass air flow”, flows through the outlet guide vane 24, then along the gas generator 30, outside the gas generator 30. This secondary air flow F2 provides by reaction the vast majority of the thrust generated by the propulsion assembly 10. The secondary air flow F2 may also make it possible to cool the gas generator 30 from the outside.

The bypass ratio (or BPR) of the propulsion assembly 10 is equal to the ratio of the mass flow rate of the secondary air flow F2 to the mass flow rate of the primary air flow F1 entering the gas generator 30. A high bypass ratio reflects the fact that most of the thrust is provided by the secondary flow F2, and that the energy provided by the primary flow F1 is mainly used to generate the secondary air flow F2. In other words, in a propulsion assembly with a high bypass ratio, the primary air flow F1 is mainly used to generate the energy to drive the propulsion module while the secondary air flow is mainly used to generate the thrust. For example, the bypass ratio of the propulsion assembly 10 may be greater than or equal to 40, for example greater than or equal to 40 and less than or equal to 80.

In a high bypass ratio propulsion assembly where the majority of the thrust is provided by the secondary flow F2, the kinetic energy of the secondary flow F2 is highly dependent on the compression produced by the propeller. One way to improve the propulsive efficiency, and therefore the overall efficiency of the propulsion assembly, is to reduce the pressure ratio of the propeller, and therefore of the propulsion module. Such a reduction in the pressure ratio may be achieved thanks to a speed reduction device, which makes it possible to reduce the rotational speed of the propeller, but also to increase the power extracted by the high-pressure turbine, which further improves the overall efficiency of the propulsion assembly.

The propulsion assembly 10 may be configured to provide a thrust between 18000 lbf (80068 N) and 51000 lbf (222411 N), for example between 20000 lbf (88964 N) and 35000 lbf (155688 N), when the propulsion assembly 10 is stationary, uninstalled, in takeoff mode in a standard atmosphere (as defined by the International Civil Aviation Organization (ICAO) manual, Doc 7488/3, 3rd edition) and at sea level.

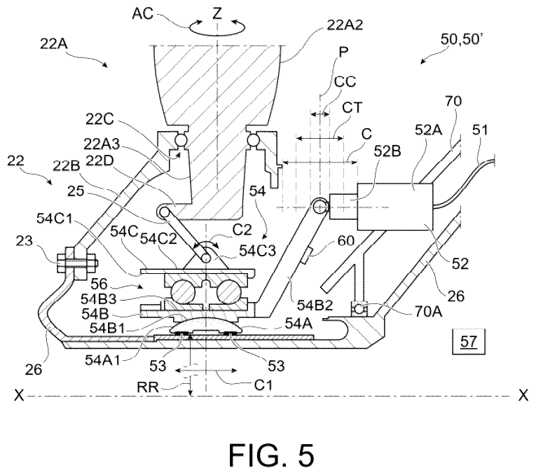

The cyclic pitch device for the blades of the propeller 50 is described in more detail with reference to FIG. 5. The cyclic pitch device 50 may comprise a plurality of cylinders 52, for example exactly four cylinders 52 (only one cylinder being shown in FIG. 5). The cylinders 52 may be of the “single chamber” type. According to a variant not shown, the cyclic pitch device 50 may comprise exactly three cylinders 52, at least one of the cylinders 52, or even all of the cylinders 52, being of the “double chamber” type. The cylinders 52 may be regularly distributed circumferentially about the axis X, for example every 90° in the case where the cyclic pitch device 50 comprises exactly four cylinders 52. The cylinders 52 may be configured to adopt a position P within a total collective pitch stroke CT, and to allow a cyclic pitch stroke CC between ±40 mm, for example between ±20 mm, for example between ±16 mm, for example between ±9.6 mm, around said position P. The cylinders 52 are for example hydraulic cylinders. Each cylinder 52 may be supplied with pressurized oil via a supply line 51, specific to each cylinder 52 and independent for each cylinder 52. These independent supply lines 51 may extend via arms 55A of the intermediate casing 55. In other words, the supply lines 51 may bypass the speed reduction device 40 and not extend through the speed reduction device 40. The pressurized oil supply circuit for the cylinders 52 may be independent and distinct from the oil supply circuit for the speed reduction device 40. Such a configuration may allow a certain modularity, and facilitate maintenance as well as assembly/disassembly of the cyclic pitch device 50. Furthermore, the independent supplies of the cylinders 52 make it possible to reduce the risks of failure of the entire cyclic pitch device 50, and to avoid a risk of collective failure of the operability of the cylinders 52. In case of failure of one of the cylinders 52 or its supply circuit, three operational cylinders 52 remain, which is sufficient to pilot the pitch ring 54 described below.

The cylinders 52 may extend parallel to the axis X, but not necessarily. The cylinders 52 may each have a cylinder 52A mounted on a stator 70 of the propulsion assembly 10, for example on a bearing support housing 70A of the propeller shaft 26. The cylinders 52 may each have a rod 52B sliding relative to the cylinder 52A, each rod having for example a distal end, in this example a fastening eyelet, sliding over a total stroke C equal to the total collective pitch stroke CT plus the cyclic pitch stroke CC.

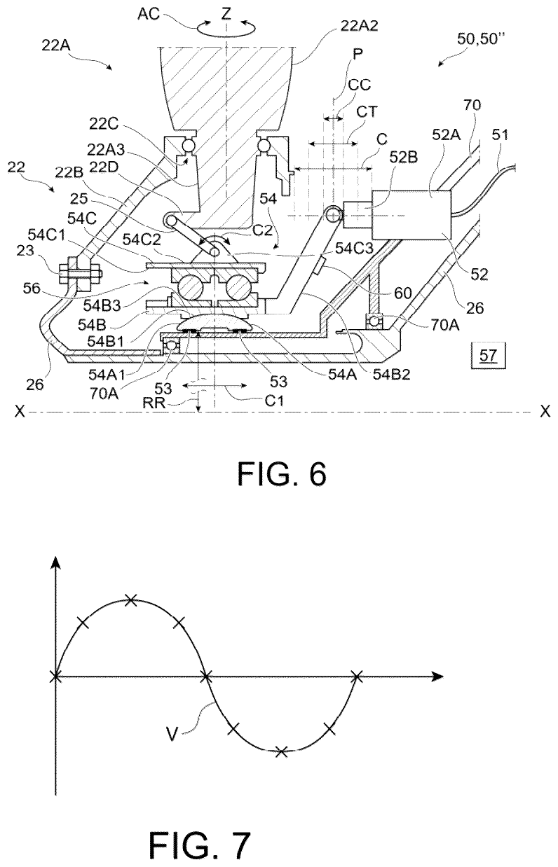

The cyclic pitch device 50 may comprise a pitch ring 54 which is statoric like the cylinder 52 and which is ball-jointed about the axis X and slides parallel to the axis X. According to a variant 50′ shown in FIG. 5, the pitch ring 54 may be slidably mounted on the propeller shaft 26. According to another variant 50″ shown in FIG. 6, the pitch ring 54 may be slidably mounted on a stator 70, for example a bearing support housing 70A of the propeller shaft 26.

The pitch ring 54 may comprise a ball joint ring 54A slidably mounted along the axis X on the propeller shaft 26 (see FIG. 5) or on the stator 70 (see FIG. 6), for example through rollers 53. These rollers 53 may be configured to allow sliding of the ball joint ring 54A along the axis X and rotation of the ball joint ring 54A about the axis X relative to the propeller shaft 26 (see FIG. 5) or relative to the stator 70 (see FIG. 6), and may thus form a sliding bearing. The ring 54A has a convex external surface 54A1 forming a ball joint.

The pitch ring 54 may comprise an internal ring 54B, for example forming an internal stator plate, disposed radially outside the ball joint ring 54A. The internal ring 54B has a concave internal face 54B1 configured to cooperate by complementarity shaping with the convex external surface 54A1 of the ball joint ring 54A. This configuration is an example providing the ball-jointed character about the axis X of the pitch ring 54. The internal ring 54B may have a plurality of arms 54B2 (a single arm being shown in FIGS. 5 and 6), extending axially and/or radially. For example, the internal ring 54B comprises as many arms 54B2 as there are cylinders 52. Each arm 54B2 may be mechanically connected to a (single) cylinder 52, for example to the distal end of a cylinder 52, for example via a ball joint or pivot connection. The internal ring 54B may comprise an external face 54B3 assembled with a radially internal portion of a rolling bearing 56.

The pitch ring 54 may comprise an external ring 54C, for example forming an external rotor plate, disposed radially outside the internal ring 54B. The external ring 54C may comprise an internal face 54C1 assembled with a radially external portion of the rolling bearing 56. In other words, the rolling bearing 56 may be disposed radially between the internal ring 54B and the external ring 54C. The internal ring 54B and the external ring 54C may thus be rotatably decoupled about the axis X. In other words, the internal ring 54B and the external ring 54C are rotatably movable relative to each other about the axis X. The external ring 54C may comprise an external face 54C2 provided with a plurality of hooks 54C3, for example eye-end clevises, to provide a mechanical connection between the external ring 54C and each of the blades 22A. For example, the external ring 54C may comprise as many hooks 54C3 as there are blades 22A.

An oil circuit not shown supplies oil to the sliding bearing formed by the rollers 53, the ball joint formed by the rings 54A and 54B, and the rolling bearing 56 of the pitch ring 54.

The pitch ring 54 may have an internal radius RR, which corresponds to the internal radius of the ball joint ring 54A, between 150 mm and 450 mm, for example 225 mm. The pitch ring 54 may be ball-jointed over an angular range C2 between ±30°, for example between ±15°, for example between ±10.5°, for example approximately ±4.0°.

Each blade 22A is pivotably mounted about its radially extending axis Z, on the hub 22B of the propeller 22, so as to be able to adjust the pitch angle of each of the blades 22A (see double arrow AC in FIGS. 5 and 6), i.e. of the airfoil 22A2 of each of the blades 22A. More particularly, in this example, the root 22A3 of each of the blades 22A is mounted on the hub 22B of the propeller 22 via a rolling 22C. It should be noted that FIGS. 5 and 6 are very schematic and that all the details of mounting the blade 22A on the hub 22B, well known elsewhere by those skilled in the art, are not shown or described. The hub 22B is rotatably coupled with the shaft 26 via an assembly for example by bolts 23

The root 22A3 of each of the blades 22 may be provided with a pitch control lever 22D, configured to pivot the blade 22 about its axis Z. The pitch control lever 22D may be connected to the pitch ring 54, via a connecting rod 25. The connecting rod 25 may be connected to the pitch ring 54 via a pivot connection or via a ball joint. The connecting rod 25 may be connected to the pitch control lever 22D via a pivot connection or via a ball joint.

When the propeller 22 rotates, the blades 22A drive, via their respective lever 22D and connecting rod 25, the external ring 54C in rotation about the axis X. The internal ring 54B being rotatably decoupled from the external ring 54C via the rolling bearing 56, and rotatably coupled about the axis X to the stator 70 via the arms 54B2 and the cylinders 52, remains rotatably stationary about the axis X. According to the inclination (provided by an angular stroke less than or equal to the angular range C2) relative to a radial plane perpendicular to the axis X of the internal ring 54B around the ball joint ring 54A, imposed by the cylinders 52, the external ring 54C follows during its rotation about the axis X the inclination imposed on the internal ring 54B. Thus, the pitch of each of the blades 22B varies during the rotation of the propeller 22. At each predefined angular position about the axis X, the blades 22A take, during their successive passage to these predefined angular positions during the rotation of the propeller 22, a pitch associated with each of these predefined angular positions. This forms an example of a cyclic pitch device.

The cyclic pitch device 50 may comprise a pressure accumulator 58 (see FIG. 2) configured to provide control energy in order to bring all the blades to the feather position. For example, the pressure accumulator 58 may be a vacuum tank, configured to purge the oil from the cylinders 52 so as to bring them into a neutral configuration corresponding to the feather position of the blades 22A. For example, the pressure accumulator 58 may be disposed in an enclosure E receiving the speed reduction device 40.

In operation, all the cylinders 52 may be controlled simultaneously and according to the same setpoint, so that the pitch ring 54 is moved along the axis X (see double arrow C1 in the example of FIGS. 5 and 6), whereby the pitch of all the blades 22A is modified to reach an identical pitch angle for all the blades 22A. This makes it possible to control and regulate the collective pitch of the blades 22A. Each cylinder 52 may also be controlled independently of one another according to a setpoint that is specific to it and different from that of the other cylinders, so that the ball-jointed pitch ring 54 pivots about a radial direction (see for example the double arrow associated with the angular range C2 in FIGS. 5 and 6), whereby the pitch of each of the blades 22A is modified in a manner that is specific to it based on its angular position during the rotation of the propeller 22. This makes it possible to control and regulate the cyclic pitch of the blades 22A. The cyclic pitch angle may be between ±30°, for example ±6° around the collective pitch position. For example, the amplitude of the ball joint angular range C2 of the pitch ring 54 may be configured so that the cyclic pitch angle is between ±30°, e.g. ±6° around the collective pitch position. For example, the cyclic pitch stroke CC of each of the cylinders 52 may be configured so that the cyclic pitch angle is between ±30°, e.g. ±6° around the collective pitch position. In the present example, the pitch device 50 may allow both cyclic pitch and collective pitch.

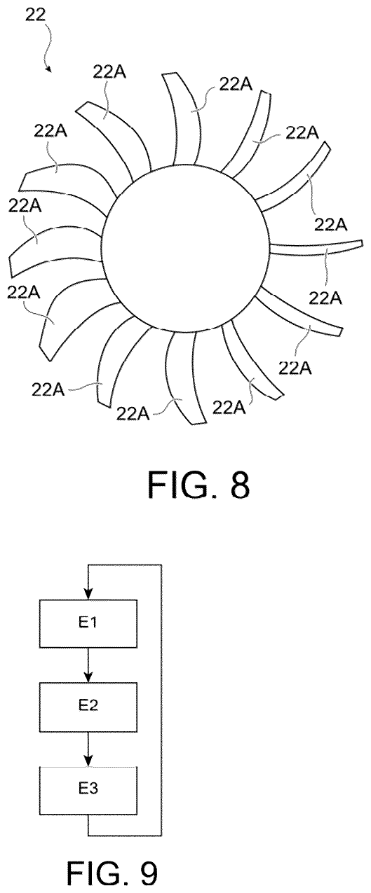

FIG. 7 represents a graph showing, on the ordinate, the pitch angle of the blades 22A based on their angular position within the propulsion assembly 10 during rotation of the propeller 22. The position of the abscissa axis on the ordinate axis corresponds to the collective pitch angle, associated for example with the position P of the cylinders 22 within the collective pitch stroke CT. The curve V corresponds to an example of cyclic pitch angles within the propeller 22, associated with a predetermined movement of each of the cylinders within the cyclic pitch stroke CC, of amplitude specific to each of the cylinders 52 and distinct from that of the other cylinders 52. Thus, in this example, during a complete revolution of the propeller 22, the cyclic pitch angle of each blade 22A follows this curve A, around the collective pitch corresponding to the abscissa. FIG. 8 represents an example of configuration of the blades 22A with a cyclic pitch: by rotating with the propeller 22, the cyclic pitch of the blades 22A evolves so that each of the blades 22A successively adopts the represented configuration.

The cyclic pitch device 50 may be configured to regulate the cyclic pitch of the blades 22A of the propeller 22 based on one or several parameters of the aircraft 100 on which the propulsion assembly 10 is mounted, for example at least one parameter among the aircraft angle of attack, the roll and the yaw. For example, the cyclic pitch device for the blades of the propeller 50 may comprise an inertial unit 57 configured to determine the angle of attack, the roll and the yaw of the aircraft 100 on which the propulsion assembly 10 is mounted. Alternatively, or additionally, the cyclic pitch device 50 may be configured to regulate the cyclic pitch of the blades 22A of the propeller 22 based on one or several parameters of the gas generator 30, for example based on at least one parameter among the speed, the power and the torque, for example the torque of a low-pressure spool. The cyclic pitch device 50 may comprise at least one sensor 60 configured to determine a 1P moment, which may be disposed for example on the propeller shaft 26, a propeller bearing support (not referenced), a member controlling the cyclic pitch device 50, for example the pitch ring 54 or a cylinder 52. In the example of FIG. 5, the sensor 60 is disposed on an arm 54B2 of the pitch ring 54. According to an example not shown, the sensor 50 may measure the pressure within the hydraulic chambers of the cylinders 52.

FIG. 9 represents a method for regulating the cyclic pitch of the blades 22A of the propeller 22 of the propulsion assembly 10, in which the cyclic pitch of the blades 22A of the propeller 22 is regulated based on at least one parameter of the aircraft 100 on which the propulsion assembly 10 is mounted and/or of at least one parameter of the gas generator 30. For example, the regulation method may comprise a regulation loop comprising a first step E1 during which at least one parameter of the aircraft 100 on which the propulsion assembly 10 is mounted is collected, for example at least one parameter among the aircraft angle of attack, the roll and the yaw, and/or at least one parameter of the gas generator 30 and/or a moment measured by the sensor 60. The method may comprise a second step E2 during which a cyclic pitch angle is evaluated. The method may comprise a third step E3 during which the cyclic pitch of the blades 22A of the propeller 22 is adjusted based on the result of the second step E2.

The present disclosure also relates to a computer program including instructions which, when the program is executed by a computer, cause the latter to implement the steps, for example E1, E2 and E3, for the execution of the method for regulating the cyclic pitch of the blades 22A of the propeller 22 of the propulsion assembly 10. This program may use any programming language, and be in the form of source code, object code, or intermediate code between the source code and the object code, such as in a partially compiled form, or in any other desirable form.

The present disclosure also relates to a computer-readable recording medium on which the computer program is recorded. The recording medium may be any entity or device capable of storing a program. For example, the medium may include a storage medium, such as a ROM, for example a CD-ROM or a microelectronic circuit ROM, or a magnetic recording means, for example a floppy disk or a hard disk.

Although the present disclosure has been described with reference to specific variations, it is obvious that modifications and changes may be made to these examples without departing from the general scope of the disclosure as defined by the claims. In particular, individual features of the various illustrated/mentioned variations may be combined in additional variations. Therefore, the description and drawings are to be considered in an illustrative rather than restrictive sense.

It is also obvious that all the features described with reference to a method are transposable, alone or in combination, to a device, and conversely, all the features described with reference to a device are transposable, alone or in combination, to a method.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A propulsion assembly for an aircraft, the propulsion assembly extending along an axis and comprising:
a propulsion module having a propeller provided with blades, an outlet guide vane, and a propeller shaft configured to drive the propeller in rotation, the blades of the propeller composed in whole or in part of composite material,
a gas generator having a drive shaft,
a speed reduction device rotatably coupling the drive shaft and the propeller shaft, and configured to drive the propeller shaft at a rotational speed lower than the rotational speed of the drive shaft, and
a cyclic pitch device for the blades of the propeller, wherein the cyclic pitch device for the blades of the propeller comprises a pitch ring ball-jointed about the axis and sliding parallel to the axis.

2. The propulsion assembly according to claim 1, wherein the propeller shaft is coaxial with the drive shaft.

3. The propulsion assembly according to claim 1, wherein the cyclic pitch device for the blades of the propeller comprises exactly three or four cylinders.

4. The propulsion assembly according to claim 3, wherein the exactly three or four cylinders are regularly distributed circumferentially about the axis.

5. The propulsion assembly according to claim 1, wherein the cyclic pitch device for the blades of the propeller comprises at least one cylinder, the at least one cylinder being configured to adopt a position within a total collective pitch stroke, and to allow a cyclic pitch stroke of one of ±40 mm, ±20 mm, ±16 mm, or ±9.6 mm, around the position.

6. The propulsion assembly according to claim 1, wherein the pitch ring is slidably mounted on the propeller shaft or on a stator.

7. The propulsion assembly according to claim 1, wherein the pitch ring has an internal radius between 150 mm and 450 mm.

8. The propulsion assembly according to claim 1, wherein the pitch ring is ball-jointed over an angular range between one of ±30°, ±15°, ±10.5°, or ±4.0°.

9. The propulsion assembly according to claim 1, wherein the cyclic pitch device for the blades of the propeller comprises a pressure accumulator configured to bring the blades to a feather position.

10. The propulsion assembly according to claim 1, wherein a cyclic pitch angle is between one of ±30° or ±6°.

11. The propulsion assembly according to claim 1, wherein the propeller has a diameter measured at a leading edge greater than or equal to 1.98 m and less than or equal to 6.12 m.

12. The propulsion assembly according to claim 1, wherein the propeller comprises at least ten blades and at most eighteen blades and wherein the propeller has a hub-tip ratio greater than or equal to 0.22 and less than or equal to 0.35.

13. The propulsion assembly according to claim 12, wherein the propeller comprises at least ten blades and at most sixteen blades and the hub-tip ratio is greater than or equal to 0.25 and less than or equal to 0.30.

14. The propulsion assembly according to claim 12, wherein the propeller comprises at least fourteen blades and at most eighteen blades and the hub-tip ratio is greater than or equal to 0.30 and less than or equal to 0.35.

15. The propulsion assembly according to claim 1, wherein the speed reduction device has a reduction ratio greater than or equal to 2.5 and less than or equal to 11.0.

16. The propulsion assembly according to claim 1, wherein the cyclic pitch device for the blades of the propeller is configured to regulate a cyclic pitch of the blades of the propeller based on one or more parameters of the aircraft on which the propulsion assembly is configured to be mounted, the one or more parameters of the aircraft comprising at least one of an aircraft angle of attack, a roll, or a yaw.

17. The propulsion assembly according to claim 1, wherein the cyclic pitch device for the blades of the propeller is configured to regulate a cyclic pitch of the blades of the propeller based on one or more parameters of the gas generator, the one or more parameters of the gas generator comprising at least one of a speed, a power, or a torque.

18. The propulsion assembly according to claim 1, wherein the cyclic pitch device for the blades of the propeller comprises at least one sensor disposed on at least one of the propeller shaft, a propeller bearing support, and a member controlling the cyclic pitch device, the at least one sensor being configured to determine a 1P moment.

19. The propulsion assembly according to claim 1, wherein the cyclic pitch device for the blades of the propeller comprises an inertial unit configured to determine an angle of attack, a roll, and a yaw of the aircraft on which the propulsion assembly is mounted.

20. A method for regulating a cyclic pitch of blades of a propeller, the method comprising:
providing a propulsion assembly for an aircraft according to claim 1; and
regulating the cyclic pitch of the blades of the propeller based on at least one parameter of the aircraft on which the propulsion assembly is configured to be mounted or based on at least one parameter of the gas generator.
